(19) United States
(12) Patent Application Publication
(10) Pub. No.: US 2024/0181350 A1
(43) Pub. Date: Jun. 6, 2024

(54) REGISTERING HAND-HELD NON-ELECTRONIC OBJECT AS GAME CONTROLLER TO CONTROL VR OBJECT POSITION, ORIENTATION, GAME STATE

(71) Applicant: Sony Interactive Entertainment LLC, San Mateo, CA (US)

(72) Inventors: Daisuke Kawamura, San Mateo, CA (US); Udupi Ramanath Bhat, San Mateo, CA (US)

(21) Appl. No.: 18/061,906

(22) Filed: Dec. 5, 2022

(51) Int. Cl. A63F 13/655; A63F 13/213; A63F 13/22; A63F 13/533; A63F 13/54

(52) U.S. Cl. CPC A63F 13/655; A63F 13/213; A63F 13/22; A63F 13/533; A63F 13/54; A63F 2300/8082

(57) ABSTRACT

A non-electronic object like a child's toy can be imaged and used to control a graphical element in a video game based on the object's location and angle. For example, the object may be used to control the graphical element to select a button presented as part of the video game. Three-dimensional (3D) features of the object can be identified during a setup process, and then the object itself can even be represented in the video game as the graphical element according to the 3D features.

### FIELD

The disclosure below relates generally to registering and using a hand-held non-electronic object as a controller to control the position, orientation, and game state of a displayed graphical element.

### BACKGROUND

As understood herein, electronic video game controllers can be very complex and prevent children below a certain age from effectively using them to play a video game.

### SUMMARY

Present principles also understand that video games like virtual reality (VR) video games can be played by a wider array of users by enabling detection of movement of non-electronic objects about the real world as input to the video game to alter game state. Thus, a player can pick out one of their own toys like a plush doll and use that toy as a game controller instead of an electronic gamepad. The player can thus move the toy itself for controlling the game's characters and other features. A depth sensing camera may be used to detect the pre-registered object, get the position and angles of the object, and export that data to the game. The game can thus receive object pose information constantly during gameplay and connect the data to various control keys.

Further, note that any object can be registered using the camera and machine learning so that kids and other people may use their own toys or other real-world objects in an intuitive way to play the VR or other type of video game. Thus, an object can be scanned and used for gameplay without that object communicating via wireless or wired analog or digital signals, providing a video game controller for kids and others that wish to use it.

Accordingly, in one aspect an apparatus includes at least one processor configured to receive input from a camera and, based on the input, identify position data related to a non-electronic object. The processor is also configured to control a graphical element of a video game based on the position data related to the non-electronic object.

In certain example embodiments, the at least one processor may also be configured to register three-dimensional (3D) features of the non-electronic object through a setup process prior to controlling the graphical element of the video game based on the position data. So, for example, the processor may be configured to execute the setup process, where the setup process includes prompting a user to position the non-electronic object in view of the camera, using images from the camera that show the non-electronic object to identify the 3D features, and storing the 3D features in storage accessible to the processor.

Also in various example embodiments, the at least one processor may be configured to, based on the position data, control a location and/or orientation of the graphical element within a scene of the video game.

Still further, if desired the apparatus may include the camera, and in certain examples the camera may be a depth-sensing camera. The apparatus may also include a display accessible to the at least one processor, and the at least one processor may be configured to present the graphical element of the video game on the display according to the position data. Also if desired, the graphical element may include a 3D representation of the non-electronic object itself. For example, the 3D representation may be generated using data from the setup process where the non-electronic object is positioned in front of the camera to register 3D features of the non-electronic object.

Still further, in certain example implementations the processor may be configured to, based on the position data related to the non-electronic object, control the graphical element of the video game to hover over/overlay on and then select a selector that is presented as part of the video game.

In another aspect, a method includes receiving input from a camera and, based on the input, identifying position data related to a non-electronic object. The method also includes controlling a graphical element of a computer simulation based on the position data related to the non-electronic object.

In one example, the computer simulation may include a video game. Additionally or alternatively, the computer simulation may represent the non-electronic object as the graphical element on a spatial reality display.

Still further, if desired the method may include, prior to controlling the graphical element of the computer simulation based on the position data, registering three-dimensional (3D) features of the non-electronic object through a setup process. Then during the computer simulation, the method may include controlling a location and/or orientation of the graphical element within a scene of the computer simulation based on the position data. Also if desired, the method may include controlling the graphical element of the computer simulation to hover over and select a button that is presented as part of the computer simulation based on the position data related to the non-electronic object.

In still another aspect, a device includes at least one computer storage that is not a transitory signal. The computer storage includes instructions executable by at least one processor to receive, at a device, input from a camera. Based on the input, the instructions are executable to identify position data related to an object that is not communicating with the device via signals sent wirelessly or through a wired connection. Based on the position data related to the object, the instructions are executable to control a graphical element of a computer simulation.

In some example implementations, the instructions may also be executable to, prior to controlling the graphical element of the computer simulation based on the position data, register three-dimensional (3D) features of the object through a setup process so that the object can be represented in the computer simulation as the graphical element according to the 3D features.

Also, if desired the object may be a first object and the instructions may be executable to use input from the camera to determine that the first object contacts, in the real world, a second object. Here the instructions may then be executable to present audio as part of the computer simulation based on the determination, with the audio mimicking a real world sound of the first and second objects contacting each other according to an object type associated with the first object and/or the second object.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows an example hardware setup consistent with present principles;

FIG. 3 shows an illustration of a user registering a toy to use as a video game controller consistent with present principles;

FIG. 4 further illustrates the user registering the toy consistent with present principles;

FIG. 5 demonstrates training that may occur as part of the registration process to register the toy consistent with present principles;

FIG. 6 shows another example where a child scans her toy for placement within a game scene consistent with present principles;

FIGS. 7A-7C and 8A-C demonstrate different actions the user may take with the toy to perform various respective actions within the video game itself consistent with present principles;

FIG. 9 shows a toy being tracked during deployment to identify location and angle of the toy, as further indicated by a pose box, consistent with present principles;

FIG. 10 shows an example graphical user interface (GUI) that may be controlled using a toy as a video game controller to select a single or multi-player game instance consistent with present principles;

FIG. 11 shows a prompt that may be presented at the beginning of a game to notify the user of how to play the game using the toy consistent with present principles;

FIGS. 12-18 show various examples of actions that may be taken with the toy to control the video game consistent with present principles;

FIG. 19 shows a toy being used to control a corresponding representation of the toy as presented on a spatial reality display consistent with present principles;

FIG. 20 shows example setup/registration logic in flow chart format consistent with present principles;

FIG. 21 shows example deployment logic in flow chart format consistent with present principles; and

FIG. 22 shows an example GUI that may be presented on a display to configure one or more options of a device or game to operate consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

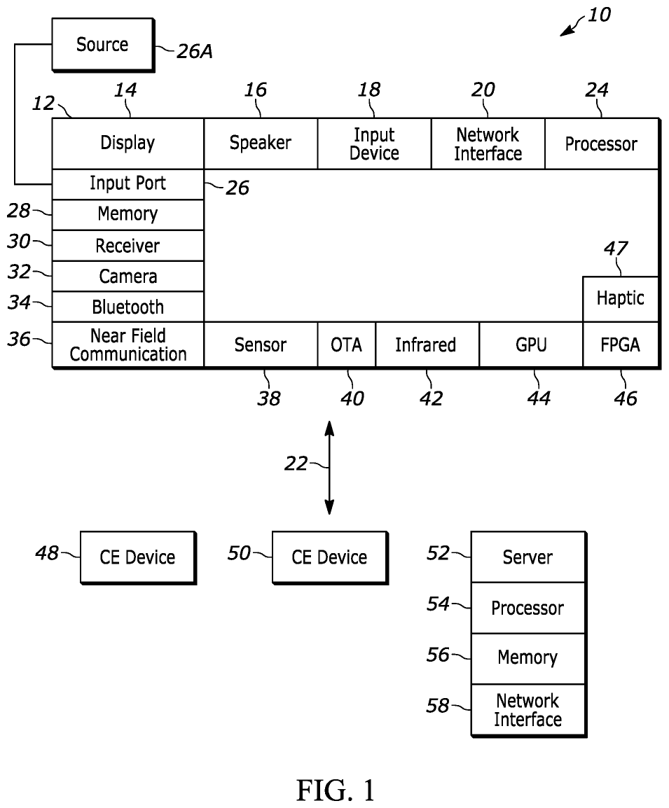

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. Other example input devices include gamepads or mice or keyboards.

The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a+1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the aforementioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

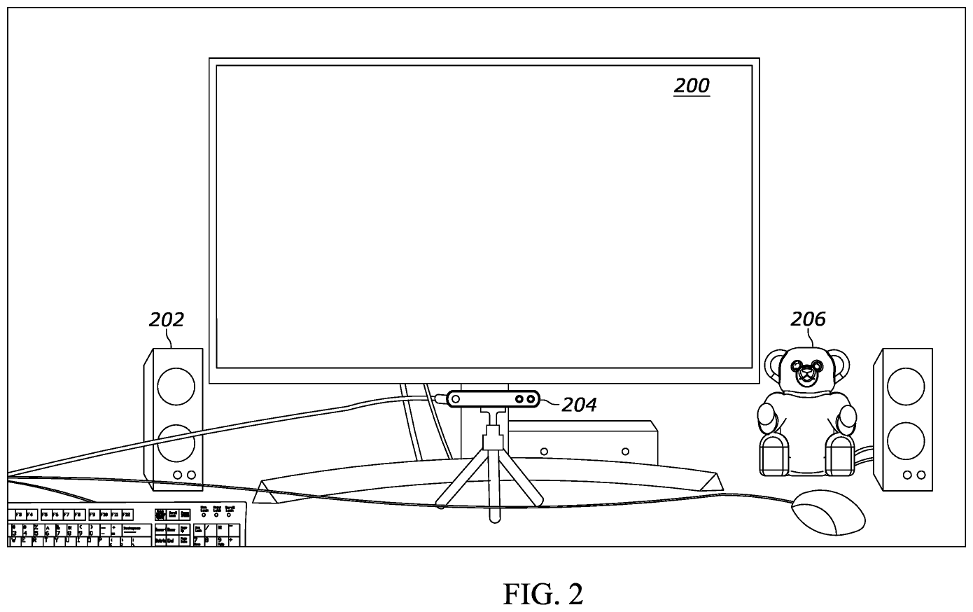

Referring now to FIG. 2, an example hardware setup consistent with present principles is shown. Specifically, FIG. 2 shows a display 200 such as a television or computer monitor. The display 200 may be connected to a computer 202 such as a personal computer or computer game console or other type of computer. The connection may be established by for example Wi-Fi communication, Bluetooth communication, wired communication via a high definition multimedia interface (HDMI) cable, wired communication via a universal serial bus (USB) cable (e.g., a USB—C type cable), etc. The computer 202 may also be similarly connected to a depth-sensing camera 204 that may include plural image sensors for sensing depth via triangulation and other techniques.

A non-electronic object 206 in the form of a stuffed animal is also shown. An end-user may thus hold the object 206 within view of the camera 204 during a setup process for the computer 202 to register the object 206, including its colors, shapes, 3D feature points, etc. This data about the object 206 may then be used to generate a 3D model representing the object 206 for incorporation of the 3D model into a scene of the video game consistent with present principles and also to control the video game itself consistent with present principles.

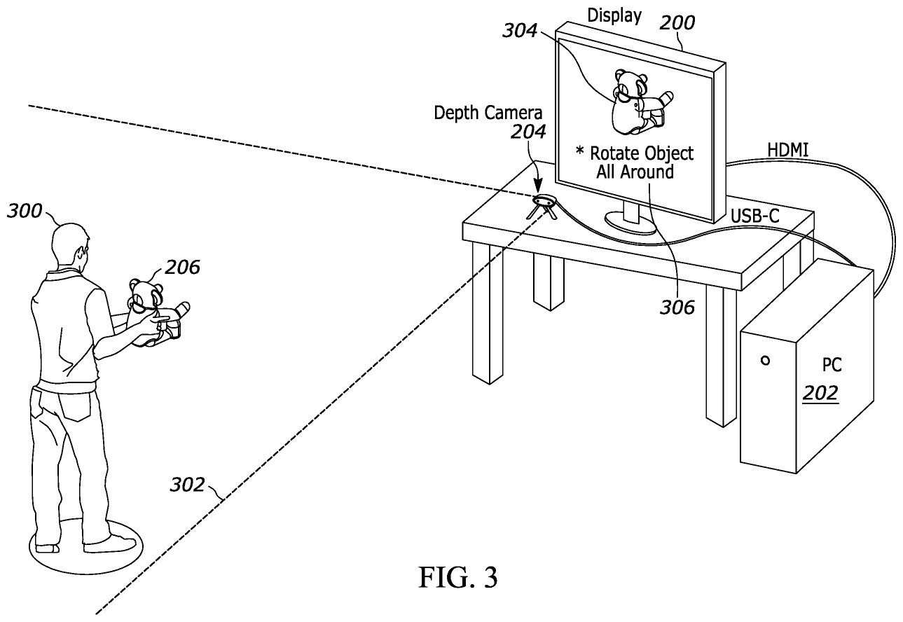

FIG. 3 further illustrates. Here again the same setup from FIG. 2 is shown, with an end-user 300 holding the object 206 up in a field of view 302 of the depth-sensing camera 204. As also shown in FIG. 3, a graphical element 304 in the form of a computer-generated 3D graphical representation of the object 206 is presented on the display 200. During this setup process, the user may register the object 206 by rotating the object 206 three-hundred sixty degrees around in each of the Y-Z plane and X-Y plane and even the X-Z plane if desired (e.g., after the computer 202 recognizes the object itself via object recognition) so that the each exposed exterior surface of the object 206 can be imaged and mapped in 3D with the depth-sensing camera 204 to generate the 3D model. In some examples, the setup process may even include presenting a visual prompt 306 instructing the user 300 to rotate the object 206 around in the Y-Z, X-Y, and X-Z planes. The text of the prompt 306 may additionally or alternatively be read aloud by a digital assistant if desired.

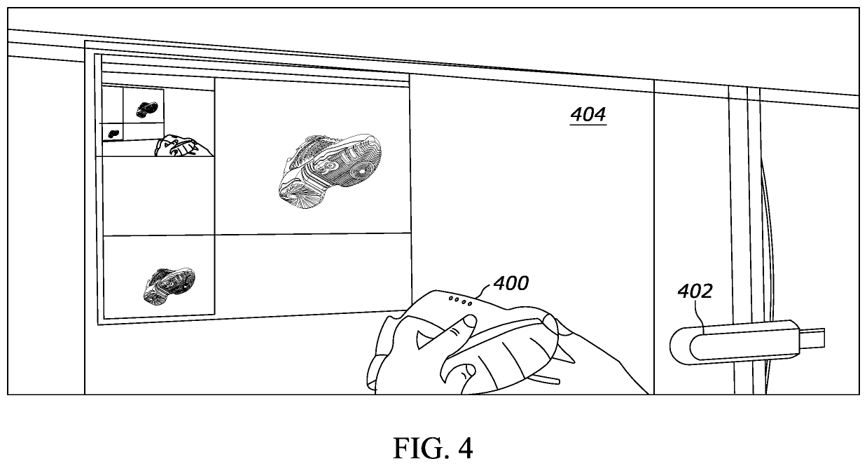

FIG. 4 illustrates even further. It shows part of the setup process for registering an object, where in this example the object is a shoe 400. As shown in FIG. 4, a 3D depth-sensing camera 402 may capture images of the shoe 400, with a display 404 showing different simultaneous images of the shoe as gathered by different image sensors on the depth-sensing camera 402. Note here that at least some of the images may be infrared (IR) images and that the depth-sensing technology that is used may be active IR stereo. However, further note that red green blue (RGB) images may also be used in addition to or in lieu of IR images.

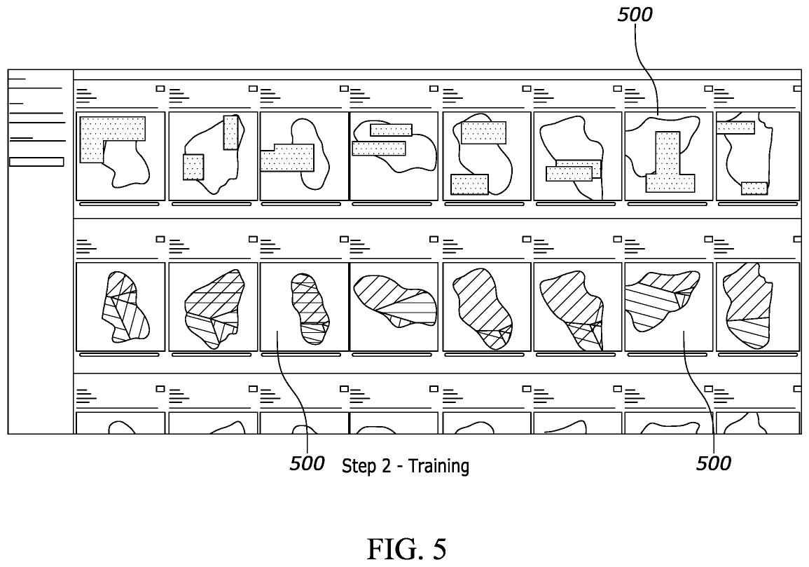

FIG. 5 then illustrates example training that may occur consistent with present principles, where machine learning may be used to train an adopted model using images from a depth-sensing camera as generated during a setup process as discussed above. The artificial-intelligence (AI)-based model that is adopted and trained may be one adept at pattern recognition, such as a convolutional neural network for example. Thus, IR and/or RGB images 500 of the shoe 400 may be used as input during training to train the model to infer, as output, orientation/angle of the shoe 400 in real world 3D space as well as location/position of the shoe 400 in real world 3D space (relative to the camera). Object recognition may also be used to identify the top, bottom, and sides of the shoe so that the training device (e.g., a server or the computer 202 for example) may autonomously label various input images as being top, bottom, left side, or right side images for performance of labeled supervised learning. However, note that other techniques may also be used if desired, including unsupervised learning. In any case, once trained the AI-based model may be deployed, with real-world images of the shoe from the depth-sensing camera being used as input to infer, as output, a position and orientation of the real-world object in 3D space to then use the position/orientation as input to the video game itself to control a corresponding graphical element within the game (e.g., a graphical 3D representation of the shoe as generated from the 3D model of the shoe).

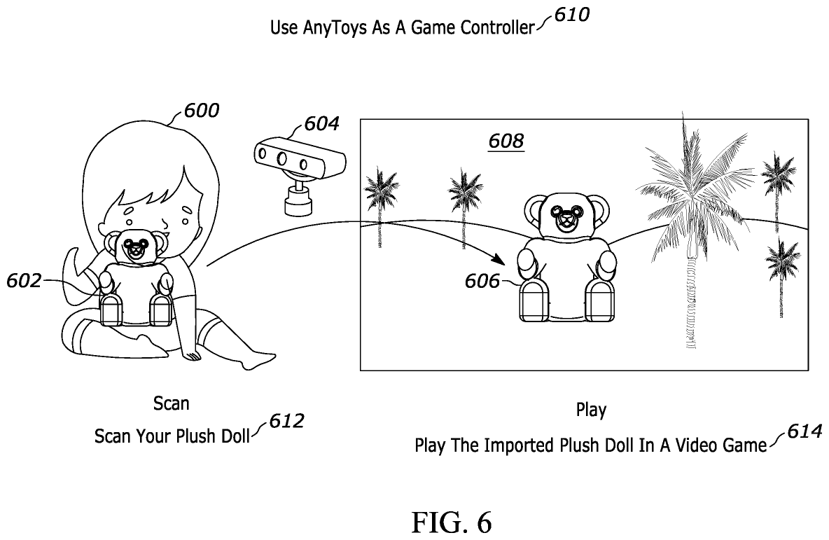

Now in reference to FIG. 6, an illustration is shown to further demonstrate present principles. A child 600 may have a stuffed animal 602, which may be imaged and mapped in 3D using a depth-sensing camera 604 as discussed herein for the computer to scan and import a 3D representation 606 of the stuffed animal 602 into a scene 608 of a virtual reality-based video game. The representation 606 can then be used as video game character that can be controlled within the game to alter game state by moving the stuffed animal 602 itself in real space (as imaged by the camera 604). Example prompts 610, 612, 614 are also shown apart from the scene 608 for illustration, with it being understood that the prompts may one or both of be read aloud and presented on the display itself that is being used to present the scene 608.

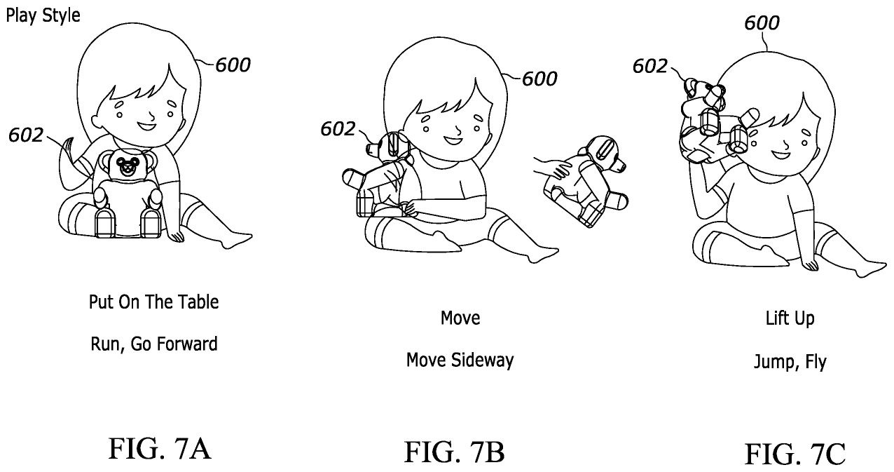

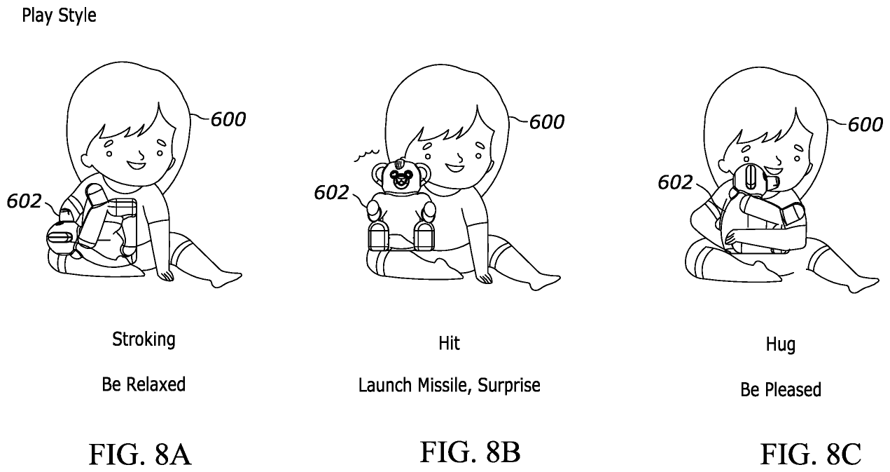

FIGS. 7 and 8 demonstrate different actions that the end-user 600 may then take to provide different kinds of inputs to the video game itself. Accordingly, FIG. 7A shows that placing the animal 602 on a table can be used as a video game input to have the corresponding graphical representation run and/or go forward through a scene of the game world. FIG. 7B shows that moving the animal 602 to the user's right may be used as a video game input to move the graphical representation to the right within the game world, while moving the animal 602 to the user's left may be used as a video game input to move the graphical representation to the left within the game world. FIG. 7C shows that lifting the animal 602 up in the Y dimension may be used as a video game input for the graphical representation to jump and/or fly.

Turning to FIGS. 8A-C and beginning first with FIG. 8A, the user 600 may interact with the animal 602 in the real world to rub or stroke the belly of the animal 602, which may be used as a video game input to show the graphical representation within the video game as being relaxed. Thus, here it is to be understood that the depth sensing camera and action recognition may be used so that not just orientation and position of the non-electronic object may be used as inputs to the video game but also so that other user interactions with the animal 602 as identified by the computer itself may be used as inputs. Accordingly, FIG. 8B further demonstrates this by showing that the user 600 hitting or tapping the animal 602 on its head may be used as video game input for the graphical representation to launch a missile or surprise attack within the video game. Similarly, FIG. 8C shows that the user 600 hugging the animal 602 may be used as video game input to show the graphical representation as being pleased.

Before moving on to other figures, note that what is shown in FIGS. 7A-C and 8A-C may be presented on a display in some instances as part of a GUI before a video game starts play. The user may thus be apprised of the different types of input available to him/her while playing the game using the toy 602. And note that the inputs/user actions themselves (motions with the toy) may be tracked via motion recognition.

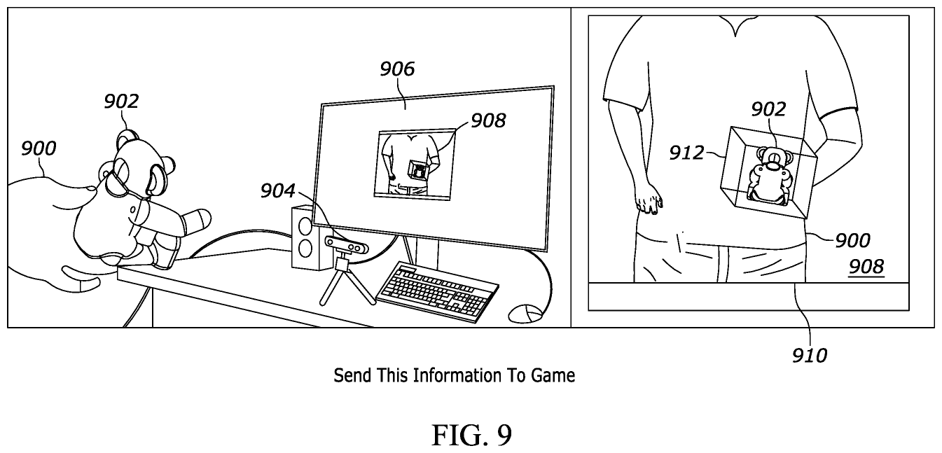

Now in reference to FIG. 9, it further demonstrates present principles. As shown in FIG. 9, a user 900 may hold a stuffed animal 902 within a field of view of a depth-sensing camera 904 that is connected to a computer (not shown) to present a real-time video feed from the camera 904 of the animal 902 in a window 908 presented on a display 906. The window 908 may show the pose estimation result for the current, real-time pose of the animal 902 as held by the user 900, with the result being determined by the AI-based model that was trained according to the description above. Exploded view 910 of the window 908 illustrates even further, where a virtual pose box 912 may be superimposed over the camera feed to demonstrate orientation/pose of the animal 902 for easier processing by the computer itself. Top, bottom, front, back, left, and right sides of the box 912 may therefore be oriented to correspond to respective top, bottom, front, back, left, and right sides of the animal 902 as bounded within the box 912 so that the orientation of the box 912 tracks the orientation of the animal 902. The pose estimation result may then be sent to the video game execution environment itself for processing consistent with present principles.

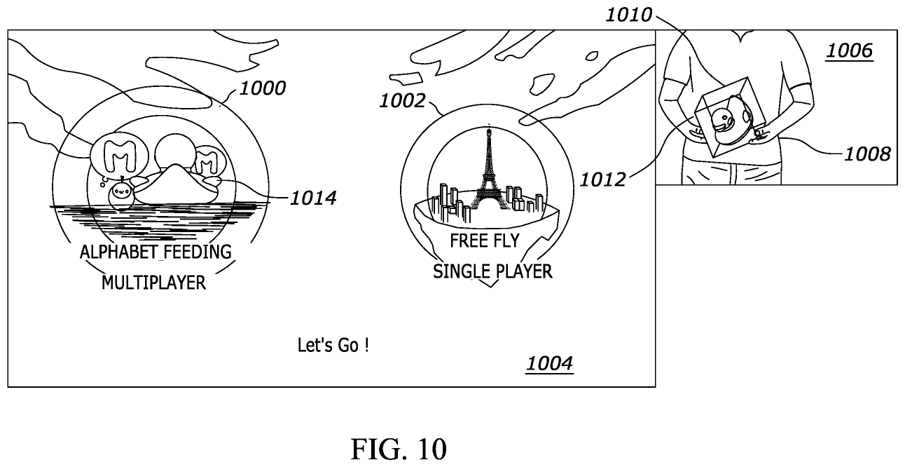

FIG. 10 shows one example type of input that may be used in a video game consistent with present principles. Here, two different selectors 1000, 1002 (buttons in this example) may be concurrently presented as part of a graphical user interface (GUI) 1004 of the video game. In this example, selector 1000 may be selected to select a multi-player game instance while selector 1002 may be selected to select a single-player game instance. A video feed 1006 from a depth sensing camera, which may or may not actually be presented as part of the GUI 1004, shows a real-world user 1008 moving a rubber ducky 1010, with a virtual pose box 1012 superimposed over the video feed 1006 and further demonstrating the current real-time orientation of the rubber ducky 1010. Accordingly, the user may change the position and orientation of the ducky 1010 in real space, which may be tracked by the computer using the depth-sensing camera to similarly move a graphical element 1014 (here, a VR-based 3D graphical representation of the ducky 1010) across the display itself according to the changes in position and/or orientation of the ducky 1010. So, for example, if the graphical element 1014 were placed in the center of the display by default, the user 1008 may hold the ducky 1010 upright and then tilt and/or move the ducky 1010 to the left to in turn move the graphical element 1014 to the left until it reaches the selector 1000 (it being understood that the user 1008 is trying to select the selector 1000). Once the element 1014 is hovering over the selector 1000, the user 1008 may return the ducky 1010 to its previous upright position to maintain the element 1014 over the selector 1000. The user may then maintain the element 1014 over the selector 1000 for a sufficient threshold amount of time to avoid false positives (e.g., three seconds) to select the selector 1000 itself.

Then, while the selected game instance is loading, the computer may present visual aids to demonstrate, using the element 1014, different actions the user may take with the ducky 1010 to provide different types of game inputs to the game. For example, aids similar to those described above in reference to FIGS. 7A-C and 8A-C may be presented. This technique may therefore help the user so the user does not have to figure out the game inputs for that specific simulation on the fly while playing.

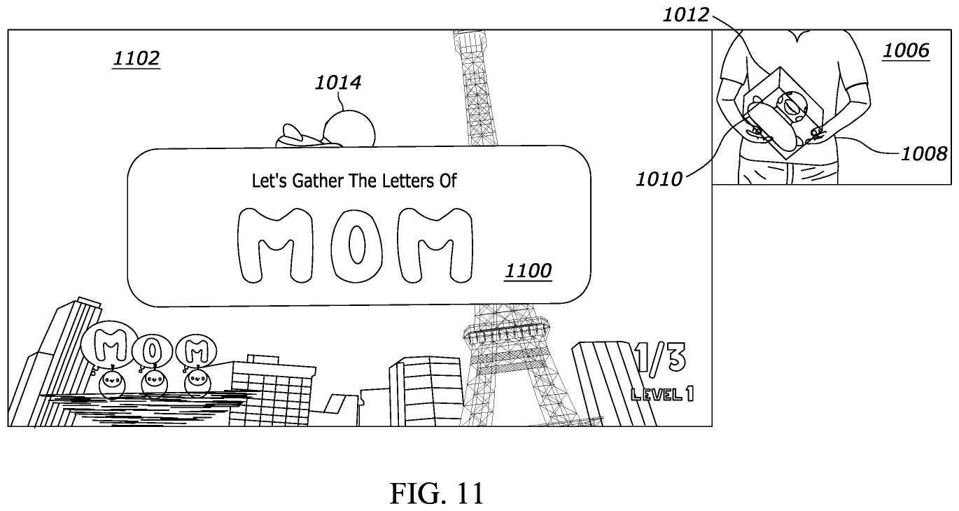

Now in reference to FIG. 11, suppose the user chose a single player game instance rather than a multi-player instance according to FIG. 10. Also suppose that, as an objective of the particular example video game to be executed, the user has to “gather” certain letters in sequence to spell the word “mom” by controlling the graphical representation 1014 to virtually collide with each letter in virtual air as each letter is presented in sequence as approaching the virtual position of the user himself/herself. FIG. 11 therefore shows that a prompt 1100 may be presented as part of a scene 1102 to indicate as much.

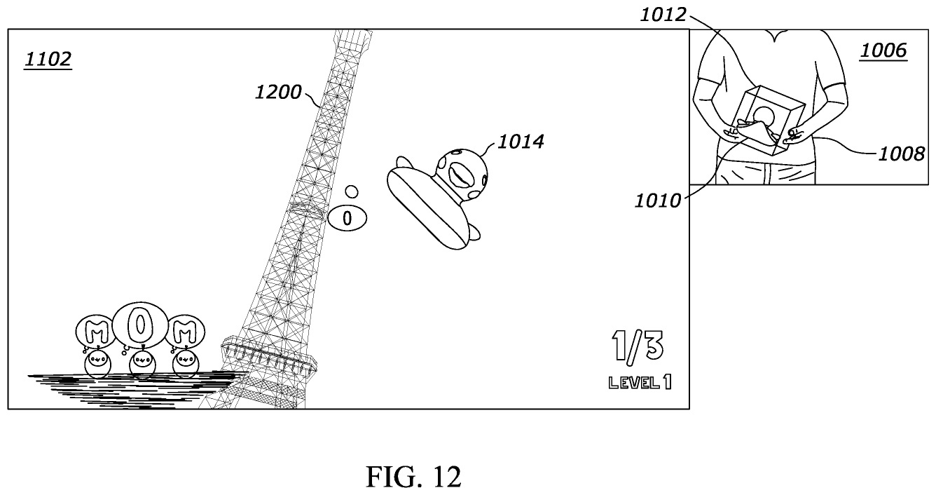

Assuming the first letter “m” has already been gathered, FIG. 12 then shows the user 1006 moving the ducky 1010 in real space to control the representation 1014 to visually overlap and virtually collide with the letter “o” as it originates from behind the tower 1200 and approaches the virtual location of the user within the game scene.

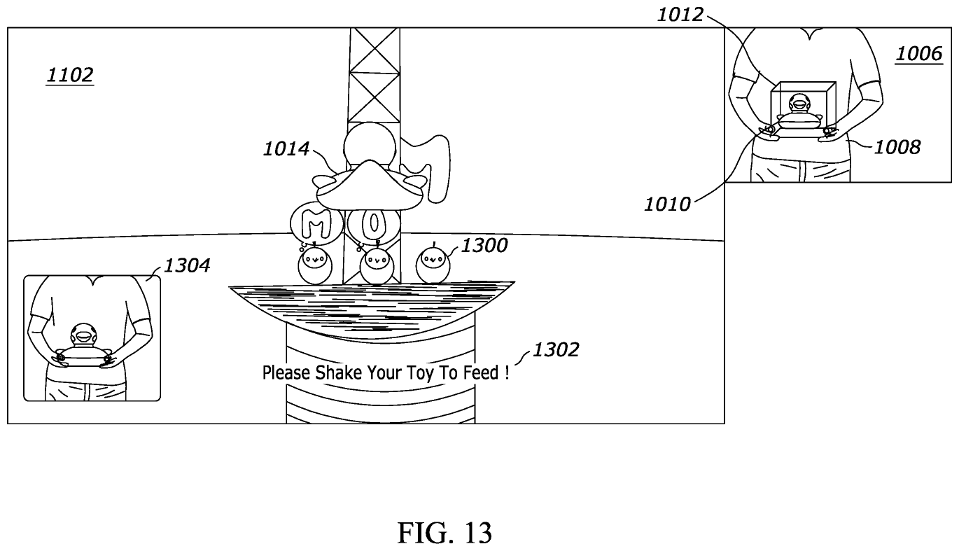

FIG. 13 shows a related example where, after gathering all the letters, the user 1006 is to shake their toy (the ducky 1010) back and forth to virtually feed the virtual chicks 1300 as another aspect of the single-player game instance. Prompt 1302 therefore indicates as much, and may be accompanied by a video or gif 1304 showing of an avatar of the user making motions with an avatar of the ducky 1010 to demonstrate actions that the user is to make with the ducky 1010 itself to feed the chicks. The video feed 1006 per FIG. 13 demonstrates the user making the corresponding real-world motions.

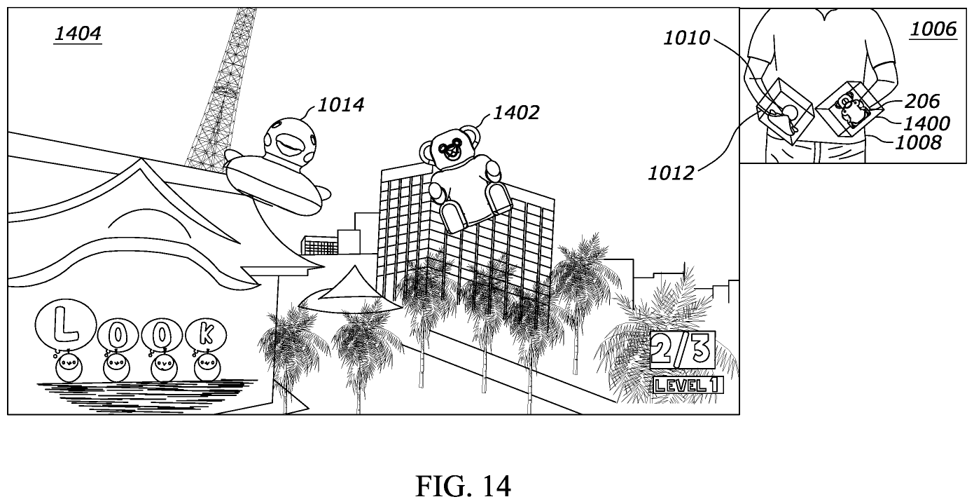

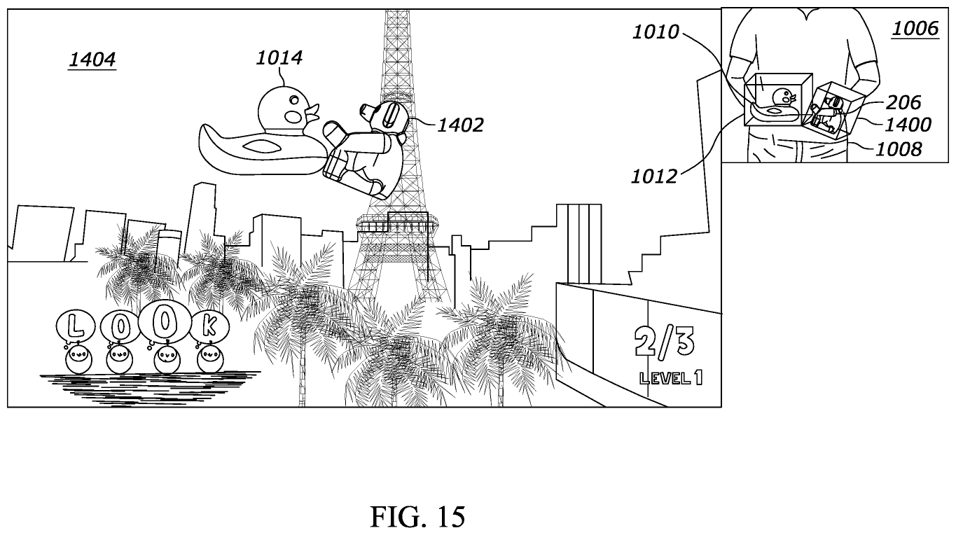

FIGS. 14 and 15 show an additional example. Here, as shown in the real-time video feed 1006, the user 1008 is holding both the rubber ducky 1010 and another non-electronic object in the form of the stuffed animal 206 described above. Also per FIGS. 14 and 15, a virtual pose box 1400 may be superimposed over raw video of the feed 1006. Based on the depth-sensing camera identifying and tracking the animal 206 in real-world 3D space (and doing the same for the ducky 1010), the computer may move both a graphical representation 1402 of the animal 206 and the representation 1014 of the ducky 1010 within the video game scene 1404 with respect to each other based on corresponding real-world movements of the objects 1010, 206 themselves. The user may perform these real-world movements for the ducky 1010 and animal 206 to physically contact each other in the real world, such as by smashing the two objects together, tapping the two objects together, rubbing the two objects together, etc. as illustrated in FIG. 15.

Accordingly, in response to determining that the two real-world objects have contacted each other in the real world, the computer may show the representations 1014 and 1402 similarly making contact in the same way as the corresponding physical objects themselves according to real-world location, orientation, speed of approach, etc. Also in response to determining that the two physical objects have contacted each other, the computer may present audio as part of the video game so that the audio is timed for real time playout at the same moment the corresponding elements 1014 and 1402 are shown on screen as contacting each other. The audio may mimic a real world sound of objects 1010, 206 contacting each other according to object types respectively associated with each object.

For example, upon recognizing each object using object recognition, the computer may access a relational database indicating respective object types for respective objects to identify an object type for the recognized object through the relational database. Additionally or alternatively, the object recognition result itself may sometimes indicate object type, such as “rubber” for the ducky 1010 or “fabric” for the animal 206. The computer may then access a database of audio files to locate a particular audio file tagged with metadata indicating that it pertains to a sound of objects of the rubber and fabric types contacting each other. The computer may then either present the corresponding audio from the file as-is, or may even alter the audio using audio processing software to even better match the actual type of contact that was identified (e.g., increase the volume based on a smash of the objects 1010, 206 together, or draw the audio out over a longer period of presentation time based on the objects 1010, 206 being rubbed together for the same amount of real world time as the presentation time). Further note that in examples where an artificial intelligence-based audio generation model might be used, the sounds of the two objects 1010, 206 contacting each other may be dynamically generated by the model as already trained to render conforming sound outputs based on two different materials contacting each other (with the two different material/object types being used as the input to the model along with the type of contact that was detected).

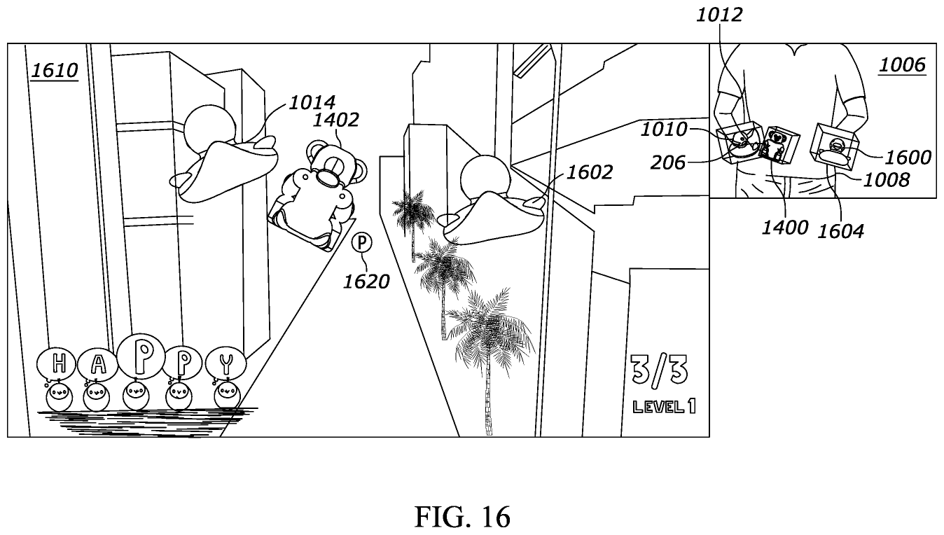

Continuing the detailed description in reference to FIG. 16, another example is shown where the ducky 1010, the animal 206, and a third non-electronic object 1600 (another rubber ducky) are shown as being held and moved by the user 1008 while a depth-sensing camera captures location, orientation, and movement of those objects in 3D space. The computer may then use the data from the camera to represent corresponding movements of the respective representations 1014, 1402, and 1602 within the video game as shown.

Note that the computer may superimpose a virtual pose box 1604 over the ducky 1600 per the video feed 1006. Also note that the representation 1602 may be a 3D representation of the ducky 1600 as taken from a 3D model of the ducky 1600, where the 3D model may be generated during a registration/training process as described above.

Thus, the user 1008 may move the physical objects 1010, 206, and 1600 to command the representations 1014, 1402, and 1602 to move correspondingly within the game scene 1610. In the present example, this entails controlling the representations to collide with the letter “P” 1620 as the representations approach it within the scene 1610. Also note before moving on that the present example might represent a multi-player game instance if, e.g., some of the objects 1010, 206, 1600 are controlled by different end-users within the same area or even by remotely-located users (each with their own depth-sensing camera).

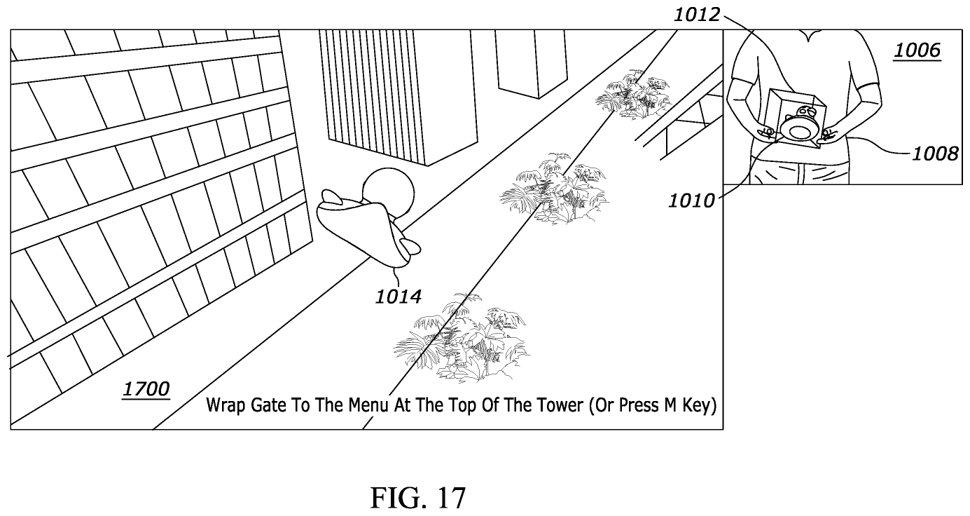

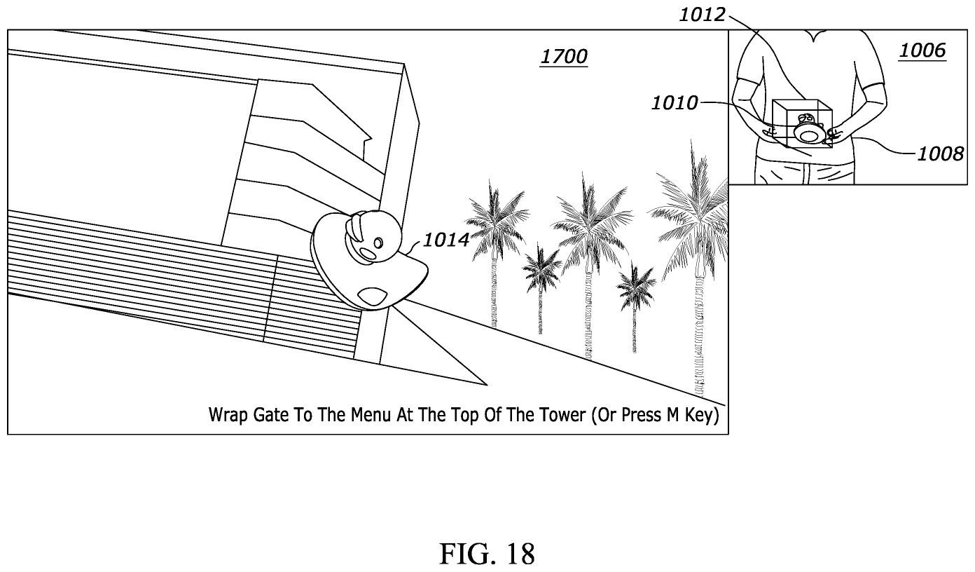

FIGS. 17 and 18 show yet another example where the ducky 1010 is moved by the user 1008 during a free fly exercise to fly the representation 1014 around within the current game scene 1700. Thus, the user may move/tilt the ducky 1010 to the left or right in the real world according the user's forward-facing perspective to command the representation 1014 to move/fly to the left or right respectively within the game scene 1700. So, for example, the degree of leftward or rightward tilting of the ducky 1010 may define a similar degree/angle of the turn itself within the scene 1700 itself. The user may also move/tilt the ducky 1010 (relative to its forward-facing axis) up to control the representation 1014 to fly up within the scene 1700, and similarly move/tilt the ducky 1010 down to control the representation 1014 to fly down within the scene 1700. Additionally, while the speed of the turn within the game might be a default that is not controllable via real-world movement of the ducky 1010 itself, in other examples turning speed/velocity of the ducky 1010 in the real world may correspond to a same turn speed for the representation 1014 in the scene 1700 itself.

In any case, per FIG. 17 note that the user 1008 tilts the ducky 1010 slightly to the left, resulting in the representation 1014 turning slightly to the left. FIG. 18 shows a different example where hard rightward movement of the ducky 1010 translates to hard leftward movement of the representation 1014 to perform a flying bank maneuver. Thus, while leftward movement of the ducky 1010 may translate into leftward movement of the representation 1014 per FIG. 17, it is to be understood per FIG. 18 that in some examples opposite movements may instead be translated so that rightward movement of the ducky 1010 translates to leftward movement of the representation 1014 and vice versa.

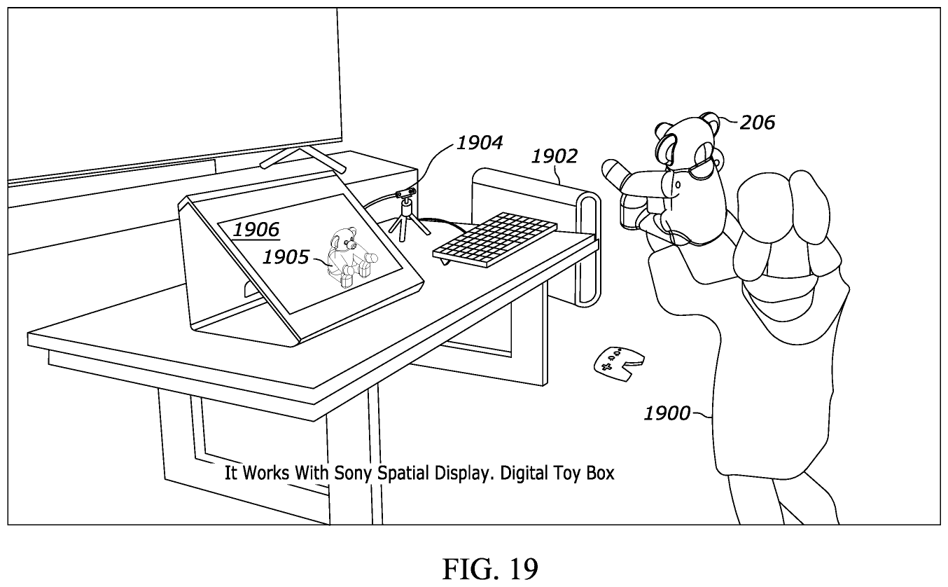

FIG. 19 shows yet another example consistent with present principles. Here, rather than playing a video game, an end-user 1900 is holding the animal 206 while a computer 1902 uses a depth-sensing camera 1904 to track the user's movement of the animal 206 to then represent corresponding movements of a graphical representation 1905 as part of a computer simulation presented on a holographic spatial reality display 1906.

Additionally, in some examples the representation 1905 may be animated to change viewing perspective based on real-world angle of view of the user themselves, giving a spatial reality effect to the representation 1905. For example, the user 1900 may leave the animal 206 stationary on a table and then walk up to the display 1906 to inspect the representation 1905 from different angles of view. Accordingly, note that to control the spatial reality display 1906, the camera 1904 may also be used to image the user's eyes so that the computer 1902 can perform eye tracking and head position tracking to change the virtual perspective of the representation 1905 according to the user's angle of view with respect to the display 1906 itself. Thus, the representation 1905 may change its presented orientation to mimic the user's actual viewing perspective toward the representation 1905 as if the representation 1905 existed in the real world and was stationary within the box mimicked via the display 1906 so that the user could simply move around the box in real-world 3D space to inspect different angles and aspects of the representation 1905 just as if inspecting the animal 206 itself from different angles. In the present example, the display 1906 may therefore be thought of as a digital toy box when representing the animal 206.

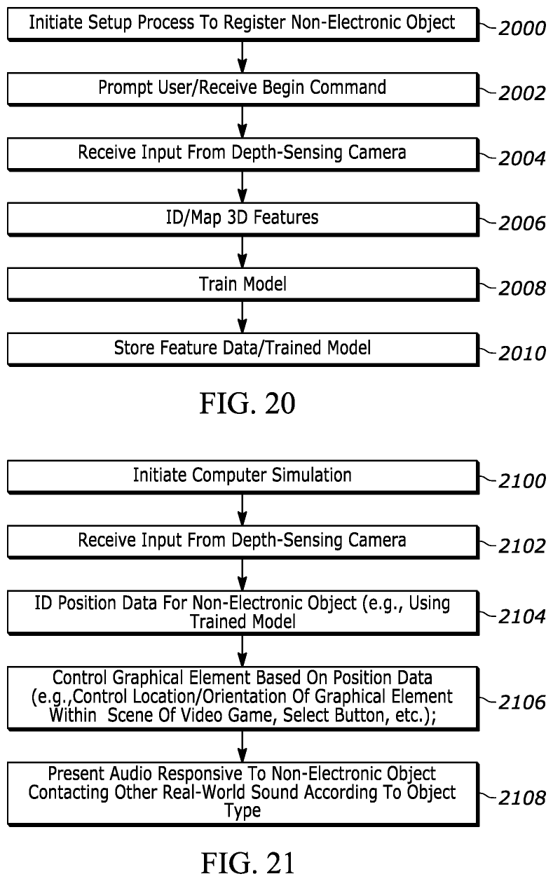

Now in reference to FIG. 20, example setup process logic is show that may be executed by a device/computer consistent with present principles. Beginning at block 2000, the computer may initiate the setup process to register a non-electronic object as referenced above. The logic may then proceed to block 2002 where the computer may prompt the user as described above in reference to FIG. 3 to position the non-electronic object in view of the depth-sensing camera and also receive a user command to begin the registration process. The logic may then proceed to block 2004 where, as part of the registration process, the computer may receive input from the depth-sensing camera to, at block 2006, use the input to identify/map 3D feature points of whatever object the user is holding to generate a 3D graphical model of the object for representation on a display. The logic may then proceed to block 2008 where the computer may train an artificial intelligence-based inference model (e.g., convolutional neural network) to make inferences about position and orientation of the real-world object that is being registered using images of the real-world object itself for accurate object-specific training to ultimately control presentation of the corresponding 3D graphical model on the display based on object position/orientation. Then the logic may move to block 2010 where the computer may store the object feature data/3D graphical model and also store the AI inference model that was trained so that the AI model may then be used during deployment to move the 3D graphical model that was generated according to real-world user movements of the corresponding real-world object.

FIG. 21 shows example logic that may then be used during deployment consistent with present principles. Beginning at block 2100, the computer may initiate a computer simulation such as a video game or spatial reality display presentation. The computer may do so by loading character, scene, and other game data for a video game into RAM for execution, for example. The logic may then proceed to block 2102 where the computer may receive input from a depth-sensing camera to, at block 2104, identify position data related to the non-electronic object being imaged. This may be done using the AI-based model trained as discussed above and the position data may relate to both position and orientation of the object within real-world 3D space.

From block 2104 the logic may then proceed to block 2106. At block 2106 the computer may synchronize/control a graphical element of the simulation based on the position data related to the non-electronic object. For example, at block 2106 the computer may control the location/orientation of the graphical element to move or select a button within a scene of the video game. Thereafter the logic may proceed to block 2108 where the computer may in some examples also present audio responsive to non-electronic objects being identified as contacting each other as described above. Thus, the audio may mimic the real-world sound of the corresponding real-world objects colliding according to object type as described above.

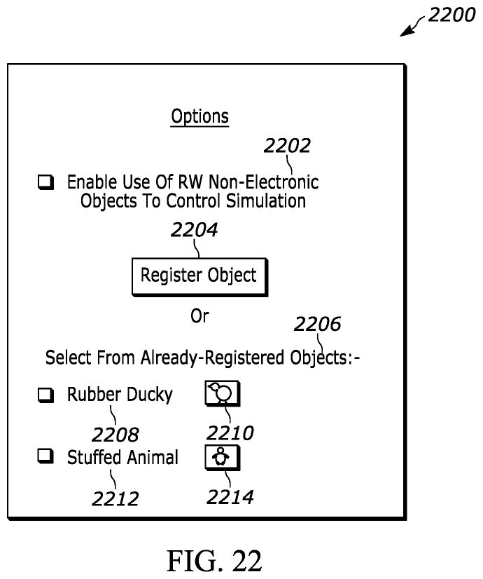

FIG. 22 shows an example graphical user interface (GUI) 2200 that may be used to configure one or more settings of a computer or computer simulation consistent with present principles. The GUI 2200 may be presented by navigating a device or operating system menu of the computer, for example. Also per this example, each option to be discussed below may be selected by directing touch, cursor, or other input to the check box adjacent to the respective option.

As shown in FIG. 22, the GUI 2200 may include an option 2202 that may be selectable to configure the computer to undertake present principles (e.g., track the real-world position and orientation of a real-world object and use that as input to control a graphical element presented on a display). Thus, selection of the option 2202 may set or enable the device to undertake the functions described above in reference to FIGS. 2-21 for example. Also note that selector 2204 may be selected to initiate the registration process itself as described above in reference to FIGS. 3-5 and 20 to register a particular non-electronic object (or another type of object that is nonetheless still not communicating with the computer via signals sent wirelessly or through a wired connection).

The GUI 2200 may also include a prompt 2206 for the user to select from already-registered objects to use one of those objects in an ensuing computer simulation as described herein. Thus, option 2208 may be selected to select the rubber ducky 1010 from above, with a thumbnail image 2210 of the ducky 1010 also being presented. Option 2212 may be selected to select the stuffed animal 206 from above, with a thumbnail image 2214 of the animal 206 also being presented.

Before concluding, note that object recognition may be executed in some instances to identify the type of real-world non-electronic object being held to then identify corresponding game movements to implement. For example, if a rubber ducky were being held according to the examples above, the computer may recognize as much and then enable the corresponding graphical element to have flying capability with animated wings that change motion based on real-world object pose (even if the real-world ducky itself does not have moveable wings). As another example, a real-world soldier figurine might be recognized to enable the corresponding graphical element to have walking and running capability with animated legs that change pace and crouch based on real-world object pose. So animations in the computer simulation can be triggered by not only the pose of the real-world object itself but also the type of real-world object.

Also note that video games and other computer simulations that may be used consistent with present principles are not limited to the examples above. For example, virtual reality and augmented reality video games and other types of simulations may also employ present principles. Also note that the graphical element controlled via the real-world non-electronic object need not necessarily be a representation of the non-electronic object itself. Itself, it might be a preexisting/pre-canned video game character that is nonetheless moveable via the non-electronic object, for example.

While the particular embodiments are herein shown and described in detail, it is to be understood that the subject matter which is encompassed by the present invention is limited only by the claims.

What is claimed is:

1. An apparatus comprising:
at least one processor configured to:
receive input from a camera;
based on the input, identify position data related to a non-electronic object; and
based on the position data related to the non-electronic object, control a graphical element of a video game.

2. The apparatus of claim 1, wherein the at least one processor is configured to:
prior to controlling the graphical element of the video game based on the position data, register three-dimensional (3D) features of the non-electronic object through a setup process.

3. The apparatus of claim 2, wherein the at least one processor is configured to:
execute the setup process, the setup process comprising:
prompting a user to position the non-electronic object in view of the camera;
using images from the camera that show the non-electronic object to identify the 3D features; and
storing the 3D features in storage accessible to the processor.

4. The apparatus of claim 1, wherein the at least one processor is configured to:
based on the position data, control a location of the graphical element within a scene of the video game.

5. The apparatus of claim 1, wherein the at least one processor is configured to:
based on the position data, control an orientation of the graphical element within a scene of the video game.

6. The apparatus of claim 1, comprising the camera.

7. The apparatus of claim 1, wherein the camera is a depth-sensing camera.

8. The apparatus of claim 1, comprising a display accessible to the at least one processor, the at least one processor configured to present the graphical element of the video game on the display according to the position data.

9. The apparatus of claim 1, wherein the graphical element comprises a three-dimensional (3D) representation of the non-electronic object.

10. The apparatus of claim 9, wherein the 3D representation is generated using data from a setup process where the non-electronic object is positioned in front of the camera to register 3D features of the non-electronic object.

11. The apparatus of claim 1, wherein the processor is configured to:
based on the position data related to the non-electronic object, control the graphical element of the video game to hover over and select a selector that is presented as part of the video game.

12. A method, comprising:
receiving input from a camera;
based on the input, identifying position data related to a non-electronic object; and
based on the position data related to the non-electronic object, controlling a graphical element of a computer simulation.

13. The method of claim 12, wherein the computer simulation comprises a video game.

14. The method of claim 12, wherein the computer simulation represents the non-electronic object as the graphical element on a spatial reality display.

15. The method of claim 12, comprising:
prior to controlling the graphical element of the computer simulation based on the position data, registering three-dimensional (3D) features of the non-electronic object through a setup process.

16. The method of claim 12, comprising:
based on the position data, controlling one or more of: a location of the graphical element within a scene of the computer simulation, controlling an orientation of the graphical element within the scene of the computer simulation.

17. The method of claim 12, comprising:
based on the position data related to the non-electronic object, controlling the graphical element of the computer simulation to hover over and select a button that is presented as part of the computer simulation.

18. A device comprising:
at least one computer storage that is not a transitory signal and that comprises instructions executable by at least one processor to:
receive, at a device, input from a camera;
based on the input, identify position data related to an object that is not communicating with the device via signals sent wirelessly or through a wired connection; and
based on the position data related to the object, control a graphical element of a computer simulation.

19. The device of claim 18, wherein the instructions are executable to:
prior to controlling the graphical element of the computer simulation based on the position data, register three-dimensional (3D) features of the object through a setup process so that the object can be represented in the computer simulation as the graphical element according to the 3D features.

20. The device of claim 18, wherein the object is a first object, and wherein the instructions are executable to:
use input from the camera to determine that the first object contacts, in the real world, a second object; and
based on the determination, present audio as part of the computer simulation, the audio mimicking a real world sound of the first and second objects contacting each other according to an object type associated with one or more of: the first object, the second object.
